(19) United States
(12) Patent Application Publication
(10) Pub. No.: US 2015/0114478 A1
(43) Pub. Date: Apr. 30, 2015

(54) Bursting Relief valve

(71) Applicant: Pierre-François Jérôme Tavard, Houston, TX (US)

(72) Inventor: Pierre-François Jérôme Tavard, Houston, TX (US)

(21) Appl. No.: 14/064,412

(22) Filed: Oct. 28, 2013

(51) Int. Cl. F16K 17/16; F16K 37/00

(52) U.S. Cl. CPC F16K 17/16; F16K 37/0058
USPC 137/14; 137/68.24

(57) ABSTRACT

The invention provides a method, apparatus and system capable of releasing excess pressure above a predetermined point by opening and closing repeatedly through the actuation of a moving element. The said moving element is capable of bursting in case of a rise in pressure above a secondary predetermined point. The invention hence provides a way to regulate the pressure in two different manners depending on the severity of the overpressure.

### BACKGROUND OF THE INVENTION

1. Field of the Invention

The present invention relates to relief elements. More specifically, the present invention relates to spring loaded relief valves and to rupture disks.

2. Background of the Related Art

Relief elements such as relief valves and rupture disks are widely known as safety devices to release overpressure from pipes and vessels. Various designs exist for both technologies, most of which allow the user to adjust the pressure at which the relief device bursts or opens.

Even though both of these technologies have the same goal, which is to regulate the pressure by releasing overpressure, relief valves are typically made to regulate smaller variations whereas rupture disks are more suitable to avoid catastrophic failure thanks to their swiftness when activating.

Although it is sometimes possible to install both types of devices in parallel, most often space limitation renders it impossible. Therefore, a need was identified for a device capable of regulating slight variations in pressure, while being fast enough to operate in response to a major overpressure.

### BRIEF SUMMARY OF THE INVENTION

Spring-loaded relief valves and bursting or rupture disks both have their own set of advantages and drawbacks. Both technologies have been improved over time, allowing a use of either with operating pressure up to 99% of the opening or bursting pressure. Nonetheless, drawbacks still remain for each technology.

Spring-loaded relief valves have been used for a long time because they can operate repeatedly with virtually no maintenance, and because of their high reliability. Nevertheless because of their design, they are not well suited for a quick flow evacuation, which is one of their main limitations.

Rupture disks, also known as bursting disks, have been used since the 1950's. Many structural designs exist and have been perfected to achieve the largest evacuation section aperture in the shortest time. Rupture disks' strength is spring-loaded relief valves' weakness. However, rupture disks have their own set of disadvantages; particularly, they can only operate once and then must be replaced.

One aspect of the invention is the use of a bursting disk as the seat of the relief valve. Hence it provides a way to regulate the pressure in two different manners depending on the severity of the overpressure. The present invention is designed to be capable of hosting the broad variety of rupture disks which exist in the industry. The type of rupture disk will be determined by the fluid and pressure at which the valve operates. These can be, but are not limited to, forward acting rupture disk, flat rupture disk, and reverse acting rupture disk.

The present invention solves drawbacks of each one of these two technologies while preserving their advantages.

### BRIEF DESCRIPTION OF THE SEVERAL VIEWS OF THE DRAWINGS

The present invention will be better understood by studying the detailed description of some particular exemplary embodiments which are taken as entirely non-limiting and are illustrated by the appended drawings. It is further to be understood that in some instances various aspects of the invention may be shown exaggerated, reduced, enlarged, or otherwise distorted to facilitate an understanding of the present invention.

In the drawings appended hereto:

FIG. 1 is a cross-sectional view of the bursting relief valve with a rupture disk shown in normal condition and maintaining the valve in a closed position. This bursting relief valve comprises flanges on both sides of the body.

FIG. 2 is similar to FIG. 1 with only one spring, concentric to the rupture disk.

FIG. 3 is an exploded view of the relief valve showing internal components.

FIG. 4 is similar to FIG. 3 with only one spring, concentric to the rupture disk.

FIG. 5 is an isometric view of the relief valve showing the front and top.

FIG. 6 is a sketch to illustrate different possible rupture disk operations.

FIG. 7 is a pressure vessel equipped with the bursting relief valve, the outlet being open to the atmosphere.

FIG. 8 is a stream equipped with the bursting relief valve, the outlet is connected to a piping and channel to a containment area (not shown).

FIG. 9 is an electrical transformer equipped with the bursting relief valve, the outlet being connected to a piping and channel to a containment tank.

### DETAILED DESCRIPTION OF THE INVENTION

The present invention relates to a method, apparatus, and system for a safety relief valve to be capable of bursting or opening and resealing, depending on the severity of the overpressure. The relief valve is exposed to the fluid pressure in a process vessel or stream and is actuated by pressures that exceed the set pressure of the relief valve.

The present invention comprises a bursting disk capable of moving within a body. Advantageously, the rupture disk can be constrained with at least one spring in order to adjust the pressure at which the moving element will operate.

The moving part is constrained to move only in one dimension, maintaining alignment with the rest of the device to allow proper resealing.

The fluid evacuation is ensured by the opening of the valve when the rupture disk assembly moves up. In the event that this opening would not be sufficient to reduce the pressure, the rupture disk would burst to prevent pressure from building up to catastrophic levels.

The device can additionally be equipped with a sensor to indicate when the opening and/or the bursting of the disk occur.

The bursting disk can adopt various shapes depending on the fluid and environment. The most common types include flat, forward acting (also known as dome-shaped), reverse acting or buckling. More advance design such as Reverse Acting Buckling Pin Bursting Disk can also be used for specific application, particularly to achieve very precise bursting pressure, for example by having opening pressure of the valve and bursting pressure of the disk very close.

A means of isolating the relief valve upstream of the bursting disk such as gate, ball, or butterfly valves may be included in order to perform maintenance on the relief valve.

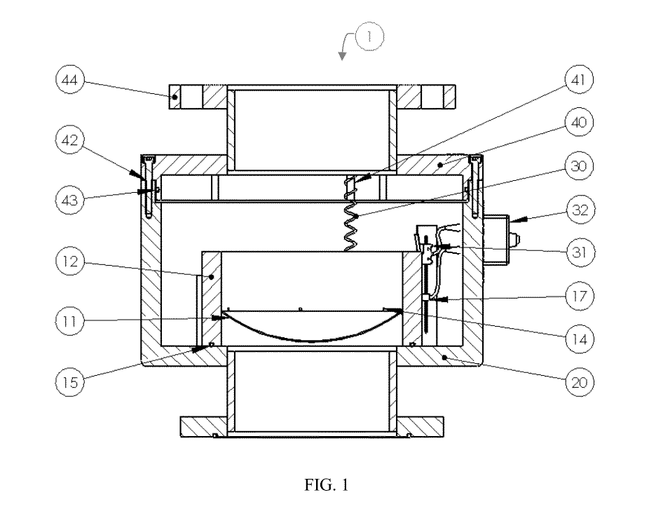

FIG. 1 is a cross-sectional view of the relief valve (1) with a rupture disk (11) shown in normal condition maintaining the valve in a closed, monitoring position. The rupture disk (11) is hosted in a holder (12) that is placed directly over the section of the inlet through which pressure will be sensed.

The body is hollow and consists of two parts, one lower (20) and one upper (40). The two parts are held together by screws (42). A gasket (43) seals the two parts together against leaks. The gasket (43) can be made of various materials depending upon the environment and with which fluid it will be in contact. These materials can be, but are not limited to, Nitrile, Nylon, fluoroelastomer (known as FKM), polytetrafluoroethylene (known as PTFE).

The lower (20) part of the body comprises a means to be connected to the fluid vessel or stream. The means of connection can highly vary and can be but is not limited to threads, flanges, or clamps. Additionally, the upper part (40) of the body may also comprise a connection mean to allow routing of the expelled fluid. FIG. 1 depicts the invention in a configuration which comprises flanges on both sides of the body.

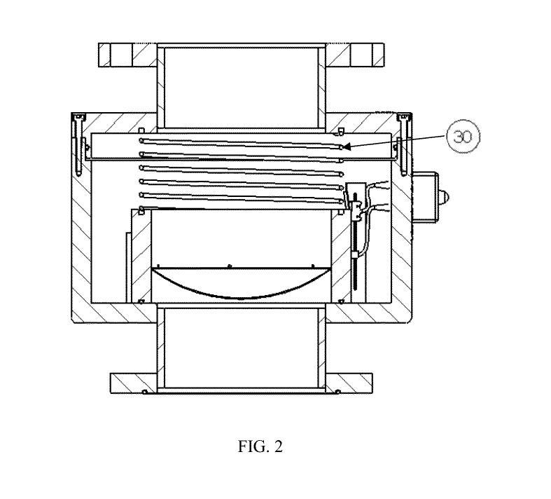

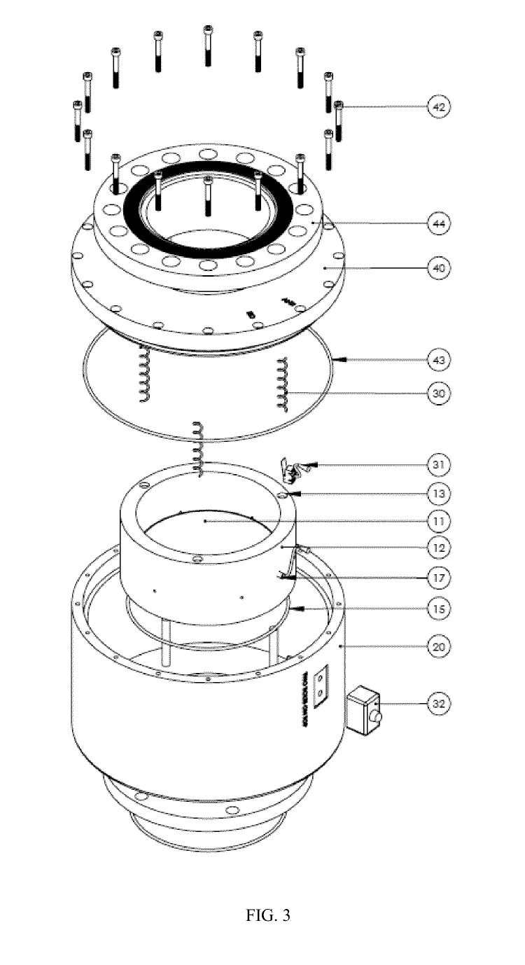

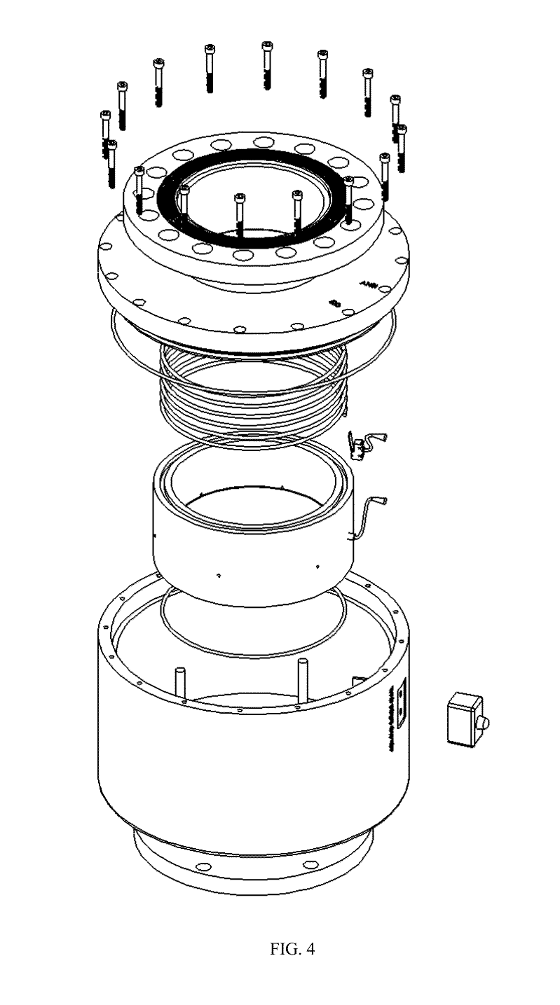

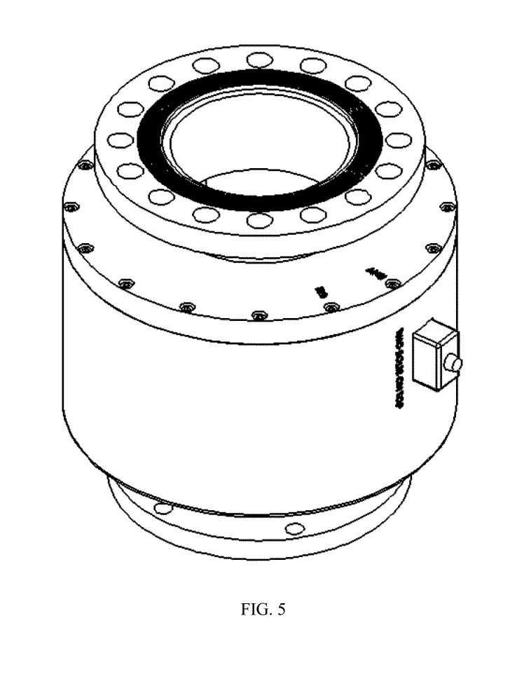

In this particular configuration, the upper part of the body (40) comprises a flange (44) which is drilled with two different patterns in order to be connected to flanges following either ANSI or ISO standards. The upper part of the body (40) is assembled with the lower part of the body (20) so that two holes of the desired pattern can be on top. Marks are provided to ease assembly of the two marks as depicted on FIG. 5. The flange (44) may be a rotary flange, in which case the flange (44) orientation is independent of the body assembly. Furthermore, the flange may be custom-made to fit any need and fulfill special requests. The lower part of the body (20) comprises a flange to allow mounting on the protected vessel or stream. The FIGS. 1 through 6 present a flange which includes a O-ring gasket.

The holder (12) may be equipped with through holes (14) to evacuate liquid from the face of the rupture disk opposite to the one exposed to the fluid. This prevents any level of liquid, and therefore weight, which could alter the valve operation.

The holder (12) is held in place relative to the inlet by studs (21) on the lower part of the body (20). The holder (12) can additionally have notches to prevent rotation along the vertical axis.

The holder (12) is maintained against the lower part of the body (20) with at least one spring (30). The spring (30) is itself maintained in position by a stub or a groove (41) of the upper part of the body (40) and a notch or a groove (13) on the holder (12).

The seal between the holder (12) and the body is ensured by a gasket (15). The gasket is typically an O-ring type. Various profiles may be used, such as X-ring which provides enhanced sealing by doubling the sealing area. The gasket is maintained in position by a groove in the holder (12). Similarly to the gasket (43), the gasket (15) can be made of various materials depending upon the environment and fluid with which it will be in contact. These materials can be, but are not limited to, Nitrile, Nylon, fluoroelastomer (known as FKM), polytetrafluoroethylene (known as PTFE).

The spring (30) is set to compressed and so to open the valve at a predetermined pressure, typically lower than the bursting pressure of the disk (11). In order to ensure proper operation, tolerances of each component are taken into consideration so that the compression pressure plus the tolerance of the spring is lower than the bursting pressure minus the tolerance of the rupture disk.

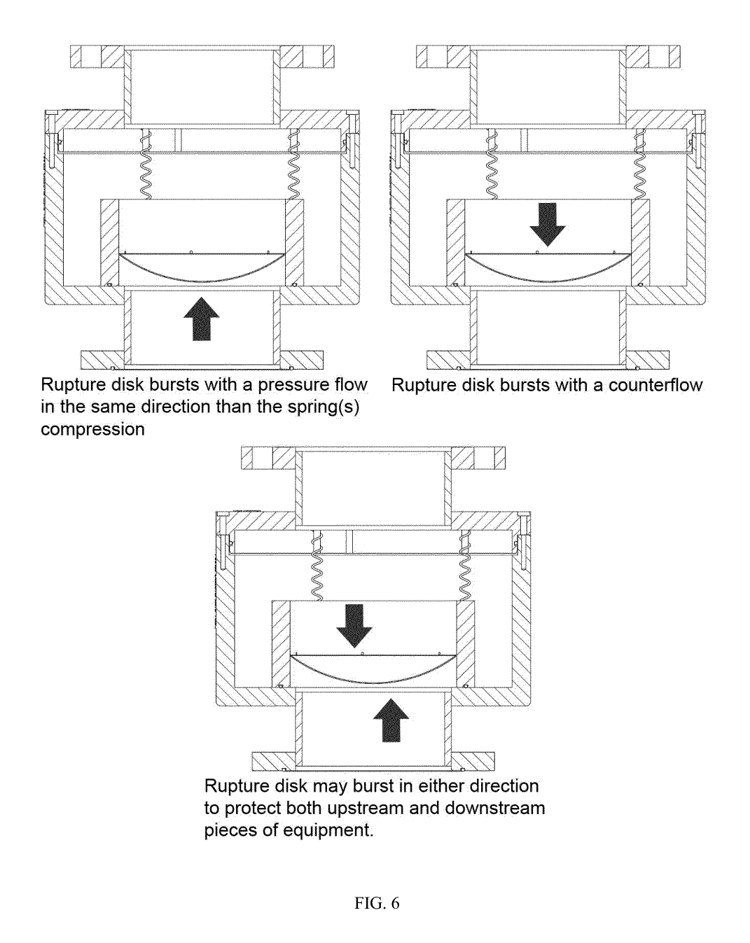

As described here afore and even though the rupture disk is typically set to burst at a secondary pressure with the same flow direction that the spring is activated, the rupture disk may be set to burst for a reverse flow, or even for either direction as shown in FIG. 6. In this case, the device may act as a non-return valve which includes a means to prevent the vessel or stream from overpressure downstream of the device.

The rupture disk (11) can be equipped with a sensor (17) to transmit the information after bursting. The sensor (17) is typically a thin electrical wire covered with a protective film which serves to prevent corrosion as well as to adhesively bond it onto the downstream face of the disk (11). The bursting of the disk (11) will force the wire to tear and break. The sensor (17) can alternatively consist of a magnetic sensor. When bursting, a small magnet fixed on the disk (11) will be forced outside of the magnetic sensor detection field. Regardless of the type of sensor used, the information on the disk being burst will be available. It is additionally possible to include a window sight on the relief valve to visually check the rupture disk and confirm that it is burst.

A second sensor (31) is used to detect the opening of the relief valve when the holder (12) is pushed toward the upper part of the body (40) by compressing the spring (30). The sensor is typically a limit switch, which is activated by the movement of translation of the holder (12) within the body. The sensor is typically installed on a support fixed relative to the body. Each sensor is wired to the connection box (32).

The relief valve may additionally comprise one or more bleed points, depending on its location on the piece of equipment protected and the type of fluid in the process. Typically, a bleed point can be located just before the rupture disk, upstream of it, to remove gas from the stream, particularly for fluid which may be diphasic. Another possibility is to have a bleed point just after the rupture disk, downstream of it, to drain fluid and particularly for liquid fluid that could remain in the relief valve body after opening. This may also be used to drain water forming from condensation.

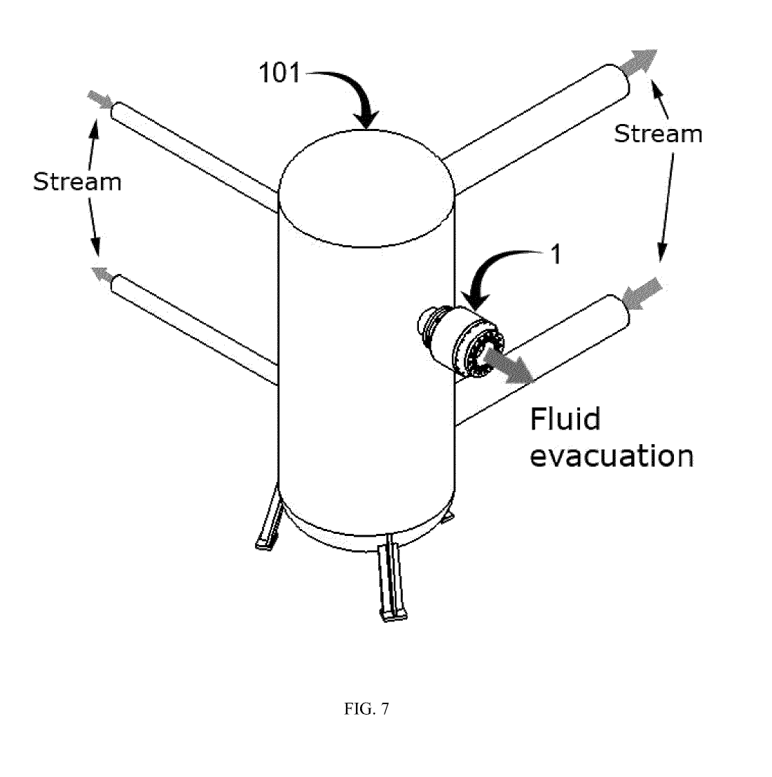

FIGS. 7, 8, and 9 show respectively a pressure vessel (101), a stream (201), and an electrical transformer (301) equipped with the relief valve; regardless of the industry, any tank or piece of equipment containing a fluid and requiring overpressure protection can be equipped with this relief valve, including electrical transformer equipment such as on load tap changer and cable box.

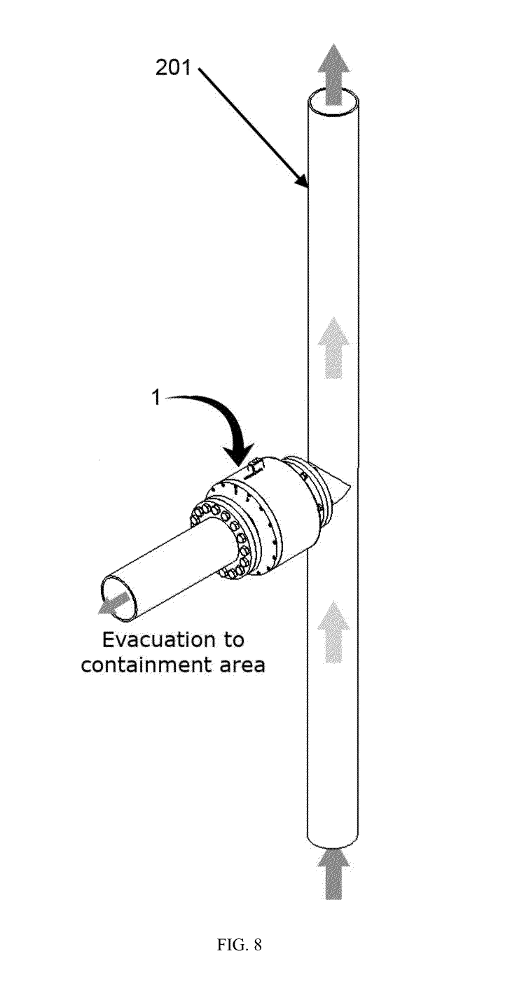

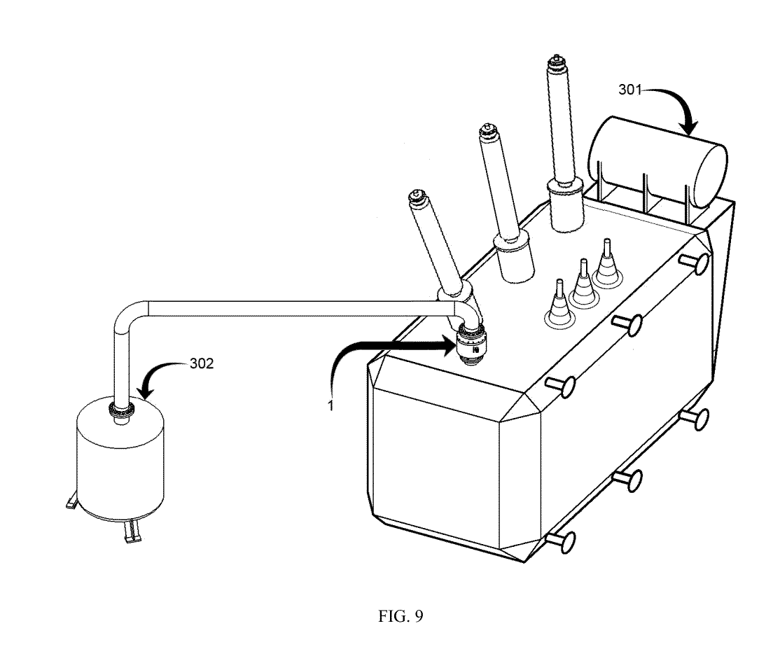

The device can be open to the atmosphere as shown in FIG. 7, or connected to piping to channel the expelled fluid as shown in FIG. 8, and which can route the fluid to a containment tank (302) as shown in FIG. 9. This setting is independent from the type of equipment protected; vessels, streams, transformers can all be either equipped with a device open to the atmosphere or not. For illustration purpose and to limit the amount of figures, not all the configurations are depicted.

The invention thus provides a relief valve which detects a rapid and tremendous rise in pressure and acts swiftly so as to limit the consequences resulting therefrom and which can be catastrophic.

The present invention may also be set forth as a method of relieving excess pressure using a relief valve which comprises a moving element to allow fluid to be expelled and capable of bursting if exposed to an extreme rise in pressure.

While the foregoing is directed to the preferred embodiment of the present invention, other and further embodiments of the invention may be devised without departing from the basic scope thereof, and the scope thereof is determined by the claims which follow.

It is noted that the embodiment of the safety relief system described herein in detail for exemplary purposes is, of course, subject to many different variations in structure, design, application and methodology. Because many varying and different embodiments may be made within the scope of the inventive concepts herein taught, and because many modifications may be made in the embodiment herein detailed, it is to be understood that the details herein are to be interpreted as illustrative and not in a limiting sense. It will be understood in view of the instant disclosure, that numerous variations on the invention are now enabled to those skilled in the art. Many of the variations reside within the scope of the present teachings. It is not intended to limit the scope of the invention to the particular forms set forth, but on the contrary it is intended to cover such alternatives modifications, and equivalents as may be included within the spirit and scope of the teachings of the present invention. Accordingly, the invention is to be broadly construed and is to be limited only by the spirit and scope of the claims appended hereto.

What is claimed is:

1. A relief system capable of releasing pressure comprising:
a. a moving element capable of opening and closing repeatedly to allow fluid to be expelled when the pressure rises above a predetermined pressure,
b. the said moving element capable of bursting to prevent catastrophic failure in case of a rise in pressure above a secondary predetermined pressure.

2. A system of claim 1 wherein the moving element is constrained by at least one spring.

3. A system of claim 1 wherein a rupture disk is comprised.

4. A system of claim 1 wherein the valve comprises a sensor capable of detecting the opening of the valve when the moving element is displaced.

5. A system of claim 1 wherein the valve comprises a sensor capable of detecting the bursting of the rupture element.

6. A system of claim 1 wherein the valve includes a drain to remove gas or liquid which may be collected.

7. A system of claim 1 wherein a window sight is used to visually check the inside.

8. A method of relieving excess pressure from a vessel, a stream, a transformer filled up with coolant fluid, an on-load tap changer, or a cable box, and providing:
a. a moving element capable of opening and closing repeatedly to allow fluid to be expelled when the pressure rises above a predetermined pressure,
b. the said moving element capable of bursting to prevent catastrophic failure in case of a rise in pressure above a secondary predetermined pressure.

9. A method of claim 8 wherein the moving element is constrained by at least one spring.

10. A method of claim 8 wherein a rupture disk is comprised.

11. A method of claim 8 wherein the valve comprises a sensor capable of detecting the opening of the valve when the moving element is displaced.

12. A method of claim 8 wherein the valve comprises a sensor capable of detecting the bursting of the rupture element.

13. A method of claim 8 wherein the valve includes a drain to remove gas or liquid which may be collected.

14. A method of claim 8 wherein a window sight is used to visually check the inside.
